(19) United States
(12) Patent Application Publication
(10) Pub. No.: US 2013/0147927 A1
(43) Pub. Date: Jun. 13, 2013

(54) STEREOSCOPIC VIDEO DISPLAY APPARATUS AND DISPLAY METHOD

(71) Applicant: Tatsuo Saishu, Tokyo (JP)

(72) Inventor: Tatsuo Saishu, Tokyo (JP)

(21) Appl. No.: 13/483,414

(22) Filed: May 30, 2012

(30) Foreign Application Priority Data
Dec. 9, 2011 (JP) 2011-270028

(51) Int. Cl. H04N 13/04

(52) U.S. Cl. 348/51; 348/E13.075

(57) ABSTRACT

A stereoscopic video display apparatus according to an embodiment includes: a display panel having a display face on which pixels are arranged in a matrix form; an active lens disposed in front of the display panel to control light rays from the pixels, the active lens being capable of conducting partial changeover on a focus state of the display face; a defocus region detection unit configured to detect a region to be subject to focus processing from an image which is input; and a drive unit configured to drive the active lens to conduct defocus processing on a region to be defocused, which is detected by the defocus region detection unit.

### CROSS-REFERENCE TO RELATED APPLICATION

This application is based upon and claims the benefit of priority from prior Japanese Patent Application No. 2011-270028 filed on Dec. 9, 2011 in Japan, the entire contents of which are incorporated herein by reference.

### FIELD

Embodiments described herein relate generally to a stereoscopic video display apparatus and display method.

### BACKGROUND

An autostereoscopic video display apparatus (without glasses) has been developed. The autostereoscopic video display apparatus includes a plane display unit having a screen formed of pixels arranged in a matrix form and an optical plate capable of refracting light rays from the pixels, provided in front of the screen of the plane display unit. The optical plate has a configuration in which, for example, a plurality of cylindrical lenses are arranged in parallel in a direction perpendicular to a longitudinal direction of them.

It is known that switchable display of a stereoscopic video and a two-dimensional video can be conducted in the autostereoscopic video display apparatus by using an active lens capable of changing the refractive index as the optical plate.

Furthermore, a stereoscopic video display apparatus capable of partially changeover between the stereoscopic video and the two-dimensional video is known. However, it is not conducted to adjust a stereoscopic video display portion finely on the basis of contents of a video.

In the autostereoscopic video display apparatus, moiré can be eliminated by disposing ridgelines of cylindrical lenses to be inclined from a column direction of a display screen or changing the pixel shape. However, there is a problem that slight moiré is generated by a manufacture error when manufacturing the stereoscopic video display apparatus and moiré is apt to be visually recognized in a region where the gray scale level or color is flat.

### BRIEF DESCRIPTION OF THE DRAWINGS

FIG. 1 is a block diagram showing a stereoscopic video display apparatus according to a first embodiment;

FIG. 2 is a diagram showing a first concrete example of an active lens 20;

FIG. 3 is a diagram showing an example in which the active lens 20 in the first concrete example is provided in front of a display panel;

FIGS. 4(a) and 4(b) are diagrams for explaining a GRIN lens;

FIG. 5 is a diagram for explaining a double refraction (birefringent) lens;

FIGS. 6(a) and 6(b) show resolution upper limit curves for explaining an example of defocus processing;

FIGS. 7(a) to 7(d) are diagrams for explaining a depth map and a monotony degree map; and

FIG. 8 is a block diagram showing a stereoscopic video display apparatus according to a second embodiment.

### DETAILED DESCRIPTION

A stereoscopic video display apparatus according to an embodiment includes: a display panel having a display face on which pixels are arranged in a matrix form; an active lens disposed in front of the display panel to control light rays from the pixels, the active lens being capable of conducting partial changeover on a focus state of the display face; a defocus region detection unit configured to detect a region to be subject to focus processing from an image which is input; and a drive unit configured to drive the active lens to conduct defocus processing on a region to be defocused, which is detected by the defocus region detection unit.

Hereafter, embodiments will be described with reference to the drawings.

### First Embodiment

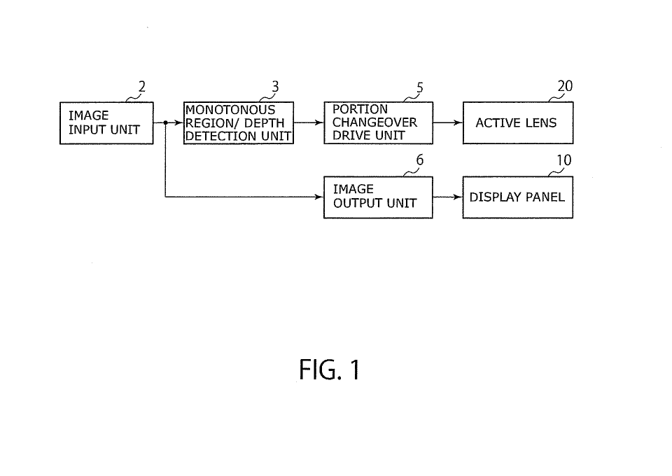

FIG. 1 shows a stereoscopic video display apparatus according to a first embodiment. The stereoscopic video display apparatus according to the first embodiment includes an image input unit 2, a monotonous region/depth detection unit 3, a portion changeover drive unit 5, an image output unit 6, a display panel 10, and an active lens 20.

The display panel 10 is a plane display panel formed of pixels arranged in a matrix form. For example, a liquid crystal display panel, a plasma display panel, an organic EL panel, or the like is used as the display panel 10.

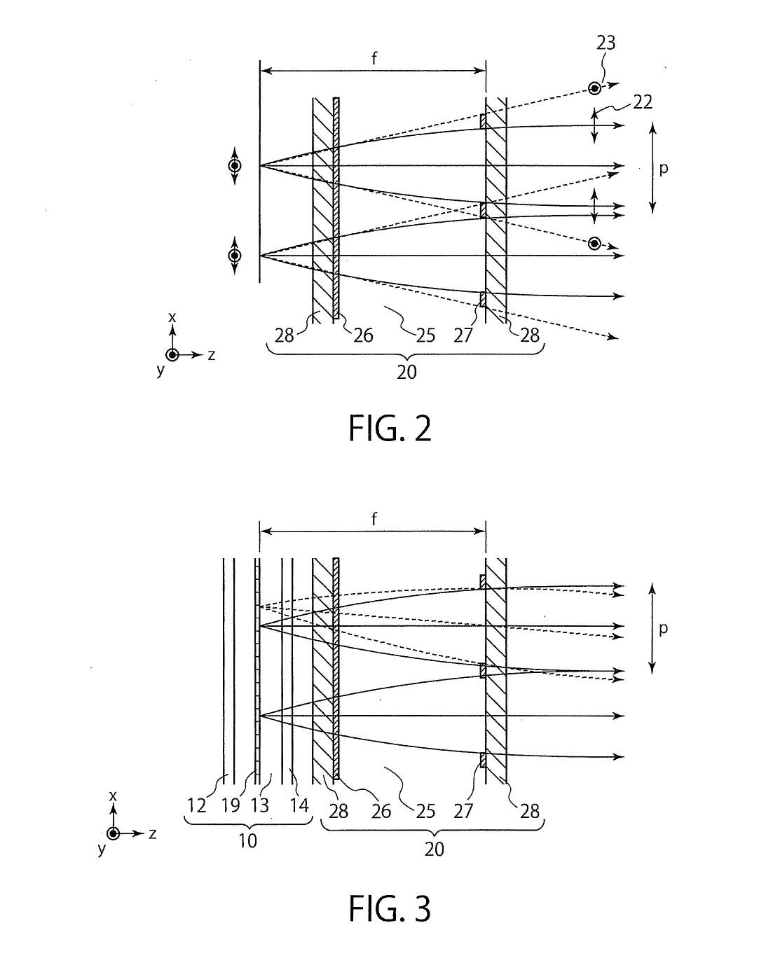

FIG. 2 shows a first concrete example of the active lens 20. The active lens 20 in the first concrete example is a liquid crystal GRIN (gradient index) lens. A common transparent electrode 26 is provided on one of two transparent substrates 28 disposed in parallel and a comb-like electrode 27 is provided on the other of the two transparent substrates 28. A liquid crystal layer 25, for example, nematic liquid crystal, blue phase liquid crystal, or the like is interposed between these transparent substrates 28. As for the method for applying a voltage to the electrodes 26 and 27, there are a case where the electrodes 26 and 27 are provided with two terminals and an AC voltage is applied to the two terminals, and a case where the comb-like electrode 27 is divided into sets of even-numbered lines and odd-numbered lines and an AC voltage is applied to three terminals.

In either case, space distribution of electric field is generated by applying a voltage between the electrodes 26 and 27, and a lens action having a pitch p and a focal length f is generated with respect to a polarized light component having a polarization direction 22. As for linearly polarized light having the polarization direction 22, therefore, the orbit is bent in the active lens 20.

As for the orientation state in the liquid crystal layer 25, the direction of the molecular major axis changes in the x-z plane. With respect to a perpendicular polarization component 23, therefore, the lens action is not conducted regardless of the voltage application state. As a result, the polarization component 23 advances straight in the active lens 20. As a matter of fact, a dielectric layer, an orientation film, or the like is provided at an interface between the electrode and the liquid crystal. However, they are not shown in FIG. 2.

FIG. 3 shows an example in which such an active lens 20 is used in front of, for example, a liquid crystal display panel used as the display panel 10. As shown in FIG. 3, a stereoscopic video display apparatus of lenticular type can be configured with respect to linearly polarized light having a polarization component in the x-axis direction by arranging pixels 19 in the liquid crystal panel 10 to locate the pixels at a focal length f of the active lens 20. In FIG. 3, the liquid crystal panel 10 has a structure in which a liquid crystal cell 13 having liquid crystal interposed between transparent substrates is interposed between sheet polarizers 12 and 14.

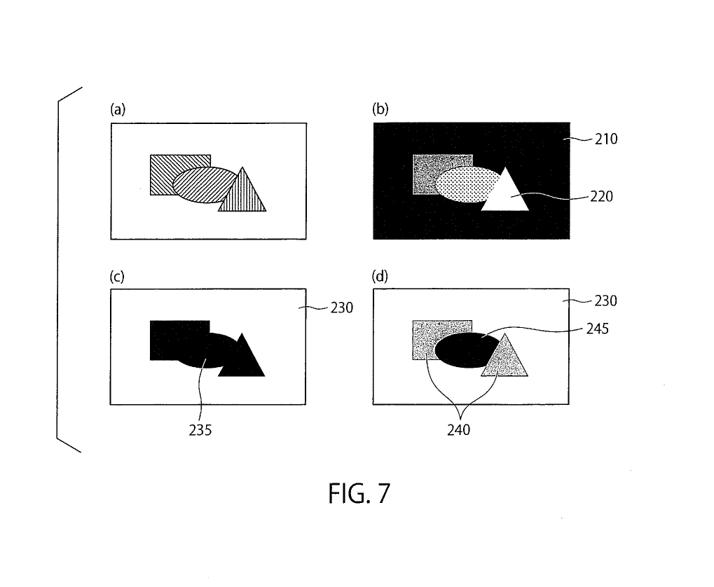

A second concrete example of the active lens 20 will now be described. The active lens 20 in the second concrete example is convex type liquid crystal lens type, and it is formed of an optical plate shown in FIG. 1 in JP-A-2010-78653 and a polarization variable cell. The active lens 20 has a configuration in which the optical plate is disposed in front of a plane display device having pixels arranged in a matrix form and a polarization variable cell is disposed between the plane display device and the optical plate. This polarization variable cell is driven by simple matrix drive (see FIG. 7 in JP-A-2010-78653). And it is possible to select a partial region (window) of a display screen and change over ON/OFF and the focus state of the active lens 20 (see FIG. 9 in JP-A-2010-78653).

In the autostereoscopic video display apparatus using such an active lens, moiré is apt to occur because of an interference effect between pixels of the display panel and the lens pitch. In general, therefore, the pixel shape and the lens angle are designed suitably to suppress moiré. In many cases, however, moiré is not eliminated completely due to a manufacturing error or the like. Such moiré which is not eliminated completely and which remains thinly is apt to be visually recognized in a region where the gray scale level/color is flat. However, such moiré is hardly recognized in other regions, giving no annoyance.

Furthermore, thin moiré can be eliminated by slightly bringing the focus of a lens out of a pixel of the display panel (defocusing). In general, defocusing causes blurring or lowers the stereoscopic sense. In the region where the gray scale level/color is flat, the image change caused by defocusing is slight, posing no problem.

In the present embodiment, therefore, control is exercised to analyze an image which is input via the image input unit 2, detect a region where the gray scale level/color is flat by using the monotonous region/depth detection unit 3, apply a voltage to the active lens 20 capable of partial changeover of the focus state via the portion changeover drive unit 5, and thereby conduct defocus processing on the detected region where the gray scale level/color is flat. At this time, image data which is input via the image input unit 2 is sent to the image output unit 6, and displayed on the display panel 10. Since the control of conducting the defocus processing on the region where the gray scale level/color is flat, it is possible in the present embodiment to prevent moiré being recognizable visually. If defocusing is conducted on a selected region in this way, the lowering of the stereoscopic sense or blurring does not pose a problem as the whole of the image.

As for the decision reference as to whether the gray scale level/color is flat, it becomes a criterion whether the variation is smaller than the spatial frequency and luminance variation width of generated moiré. For example, if moiré having a repetition period of 2 cm in spatial frequency in a 55-inch screen and a luminance variation of 1% appears, then defocus processing should be conducted when a variation which is shorter than the 2 cm period is 1% or less. As for the defocus processing, for example, the focal length should be shifted by approximately 0.5 mm to 1.0 mm to bring the luminance variation to 0.5% or less. The control of the focal length is exercised by applying voltages of a different combination to a plurality of electrodes in the GRIN lens which allows partial changeover or applying different voltages to polarization switching cell for partial changeover lens control.

In the autostereoscopic video display apparatus using the active lens, the display resolution is limited by densities of light rays emitted in a large number of directions. As the projection or depth of a portion becomes larger, therefore, the resolution falls and blurring occurs. However, blurring of a video which is large in projection or depth can be reduced by slightly bringing the focus of the lens out of a pixel in the display panel (defocusing) (see T. Saishu et al., Proc. SPIE Vol. 6778 67780E-1, or JP-A-2009-237461).

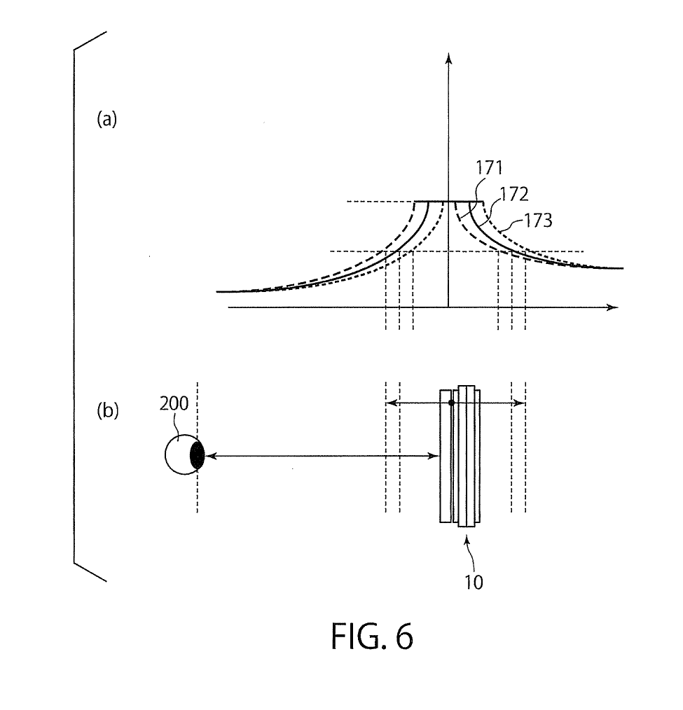

Blurring is reduced by shortening the focal length in the case of a video having a projection and by prolonging the focal length in the case of a video having a depth. In the present embodiment, the monotonous region/depth detection unit 3 detects the projection/depth region by analyzing the video which is input via the image input unit 2. And defocusing control is exercised on a region where the projection/depth is great by applying voltages of a different combination to the active lens 20 which allows partial changeover of the focus state. At this time, image data which is input via the image input unit 2 is sent to the image output unit 6 and displayed on the display panel 10. In the present embodiment, defocusing control exercised on the region where the projection/depth is great and consequently the blurring can be reduced. As for a decision reference as to whether the projection/depth is great, it becomes a criterion whether a resolution upper limit curve shown in FIG. 6(a) described later becomes less than 1 or a certain value, for example, 0.5. For example, if the projection/depth which makes the resolution upper limit curve equal to 0.5 in the 55-inch display apparatus is ±10 cm with a display face taken as the reference, defocus processing should be conducted on a region where the projection/depth is greater than it. As for the defocus processing, for example, the focal length should be shifted by approximately 0.5 mm to 1 mm. The control of the focal length is exercised by applying voltages of different combinations to a plurality of electrodes in the GRIN lens which allows partial changeover of the focus state or applying different voltages to a polarization switching cell for lens which allows partial changeover.

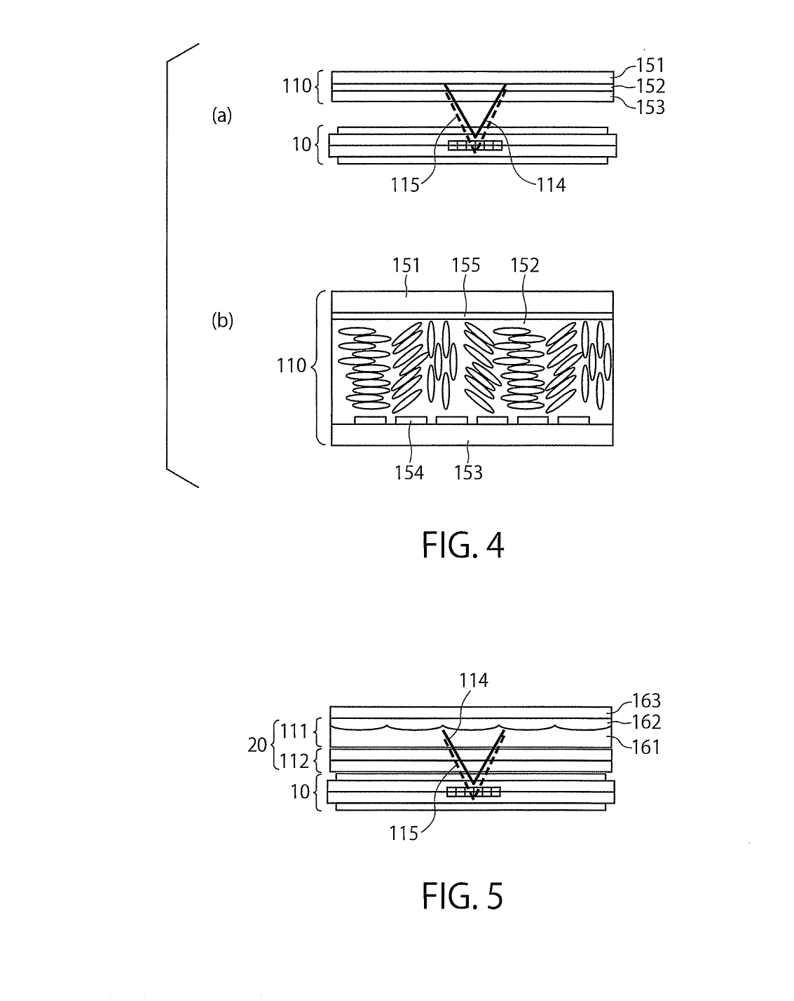

The GRIN lens used as the active lens 20 in the present embodiment will now be described with reference to FIGS. 4(a) and 4(b). FIG. 4(a) is a sectional view showing a GRIN lens 20 disposed in front of the display panel 10, and FIG. 4(b) is a partial expanded view of the GRIN lens. A GRIN lens 110 disposed in front of the display panel 10 includes two transparent substrates 151 and 153 and a liquid crystal layer 152 interposed between these transparent substrates 151 and 153. A plurality of electrodes 155 arranged in parallel along a first direction are provided on a plane of the transparent substrate 151 opposed to the transparent substrate 153. A plurality of electrodes arranged in parallel along a second direction perpendicular to the first direction are provided on a plane of the transparent substrate 153 opposed to the transparent substrate 151. In other words, the electrodes 154 and the electrodes 155 constitute electrodes of simple matrix type.

In the GRIN lens 110 having such a configuration, the arrangement state of liquid crystal in the liquid crystal layer 152 can be changed to change the focal length of the GRIN lens 110 from infinitely remote (lens off-state) to the vicinity of a pixel on the display panel by changing voltages applied to the plurality of electrodes 154 and 155. Reference numerals 114 and 115 denote light rays in the case where the focal length of the GRIN lens 110 is changed to the vicinity of a pixel. In this way, it becomes possible to conduct fine adjustment to bring the lens into the on-state in the vicinity of a pixel by changing the voltages applied to the electrodes 154 and 155 of the GRIN lens 110. As a result, the moiré and blurring can be reduced in the three-dimensional video display state.

A double refraction (birefringent) lens 111 and a polarization switching cell for lens control 112 allowing partial changeover which are used as the active lens 20 in the present embodiment will now be described with reference to FIG. 5. FIG. 5 is a sectional view showing the double refraction lens 111 and the polarization switching cell for lens control 112.

The double refraction lens 111 is provided in front of the display panel 10, and the polarization switching cell for lens control 112 is provided between the display panel and the double refraction lens 111. The double refraction lens 111 includes a transparent substrate 161 having a plurality of lens-shaped concave portions formed on its surface, a transparent substrate 163, and a liquid crystal layer 162 interposed between the transparent substrate 161 and the transparent substrate 163. By the way, lens-shaped concave portions may be provided on a face of the transparent substrate 163 as well, opposed to the liquid crystal layer 162 in positions corresponding to the concave portions of the transparent substrate 161.

In the polarization switching cell for lens control 112, liquid crystal is interposed between two transparent substrates, i.e., first and second transparent substrates, and a plurality of first electrodes and a plurality of second electrodes are provided on the first and second transparent substrates, respectively. These first and second electrodes are disposed to be perpendicular to each other. The focal length of the lens can be changed from infinitely remote (lens off-state) to the vicinity of a pixel on the display panel by changing a voltage applied to the polarization switching cell for lens control 112. Reference numerals 114 and 115 denote light rays in the case where the focal length of the double refraction lens 111 is changed to the vicinity of a pixel. In this way, it becomes possible to conduct fine adjustment to bring the lens into the on-state in the vicinity of a pixel by changing the voltages applied to the first and second electrodes of the polarization switching cell for lens control 112. As a result, the moiré and blurring can be reduced in the three-dimensional video display state.

FIG. 6(a) shows an example of the resolution upper limit curve. A curve in a state in which the focal length matches a pixel is denoted by a reference numeral 172. In a case of a curve 171 where the focal length is shortened, blurring on the projection side is reduced. In a case of a curve 173 where the focal length is lengthened, blurring on the depth side is reduced. By the way, FIG. 6(b) is a top view showing a position relation between a viewer 200 and the display panel 10.

A depth map and a flatness degree (monotony degree) map will now be described with reference to FIGS. 7(a) to 7(d). FIG. 7(a) shows an original video. FIG. 7(b) shows a depth map, and a depth side region 210 is depicted black whereas a projection side region 220 is depicted white. FIG. 7(c) shows a monotony degree map, and a region 230 where the gray scale level or color is flat (monotonous) in the original video is depicted white whereas a fine region 235 is depicted black. FIG. 7(d) shows an example of a map showing a region to be subject to defocus processing on the basis of FIG. 7(b) and FIG. 7(c). A partial region 230 depicted white is subject to defocus processing because it is monotonous. A region 240 depicted gray is defocused depending upon projection/depth. A region 245 depicted black is not subject to defocus processing. If a region where defocus control is possible is limited to a rectangle, then the defocus processing region shown in FIG. 7(d) is associated with it approximately.

According to the present embodiment, control is exercised to conduct defocus processing on a region where the gray scale level/color is flat and consequently it is possible to make moiré visually unrecognizable, as described heretofore. If a region is selected and defocused in this way, the falling of the stereoscopic sense or blurring does not pose a problem as the whole of the image.

Furthermore, in the present embodiment, control is exercised to defocus on a region where projection/depth is great. As a result, blurring can be reduced.

### Second Embodiment

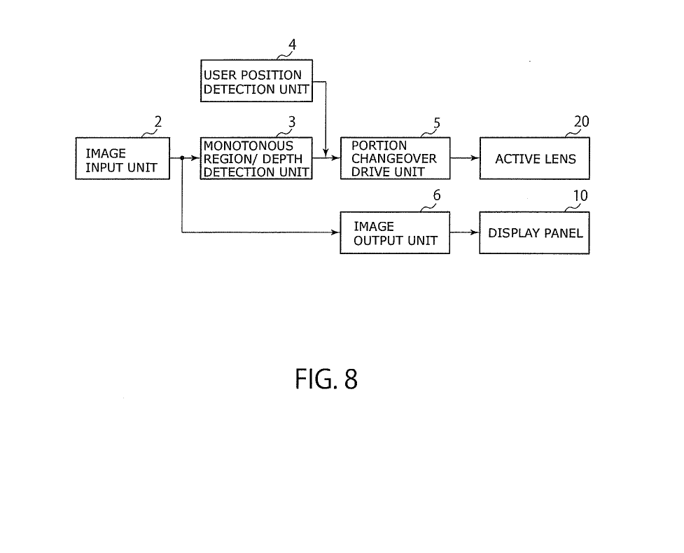

A stereoscopic video display apparatus according to a second embodiment will now be described with reference to FIG. 8. The stereoscopic video display apparatus according to the second embodiment has a configuration obtained by providing a user position detection unit 4 in the configuration of the first embodiment shown in FIG. 1. The user position detection unit 4 is typically provided in a frame of the display panel 10 to detect a position of the user (viewer) with respect to the display panel. The detection of the position is conducted by, for example, detecting a face of the viewer.

In general, in the autostereoscopic video display apparatus using a lens, the viewing zone is narrow and consequently the autostereoscopic video display apparatus using a lens can be configured to have a function of widening the viewing zone by using a face tracking function. In the present embodiment, the function of widening the viewing zone by means of the face tracking function using the user position detection unit 4 is included.

Furthermore, the focus state of the lens depends upon the angle or distance at which the viewer views. If the angle is large, there is a case where the focus state is originally poor. Furthermore, conversely, there is also a case where the focus state is good. There is also a case where the defocus processing should not be conducted for some angle range or viewing distance.

In a case where the viewer views from a certain viewpoint with an angle in the face tracking, for example, in a case where there is an angle of at least 20 degrees from the front, therefore, defocus processing described with reference to the first embodiment is not conducted. In a case where the viewer views from some distance in the face tracking, for example, in a case where the supposed viewing distance is 3H, it is also possible to adopt a configuration in which the defocus processing described in the first embodiment is conducted to shorten the focal length in a distance shorter than that and lengthen the focal length in a distance longer than that. H represents a height of display area of the display panel.

In the second embodiment as well, it is possible to prevent moiré from being visually recognizable and reduce blurring.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. A stereoscopic video display apparatus comprising:
a display panel having a display face on which pixels are arranged in a matrix form;
an active lens disposed in front of the display panel to control light rays from the pixels, the active lens being capable of conducting partial changeover on a focus state of the display face;
a defocus region detection unit configured to detect a region to be subject to focus processing from an image which is input; and
a drive unit configured to drive the active lens to conduct defocus processing on a region to be defocused, which is detected by the defocus region detection unit.

2. The stereoscopic video display apparatus according to claim 1, wherein the region to be defocused is a region where a gray scale level or color is monotonous, or a region where a projection or depth quantity is larger as compared other regions.

3. The stereoscopic video display apparatus according to claim 1, wherein the defocus processing is conducted by shifting a focal length of the active lens.

4. The stereoscopic video display apparatus according to claim 1, wherein
the active lens is a GRIN lens, and
the defocus processing is conducted by applying voltages of different combinations to the GRIN lens.

5. The stereoscopic video display apparatus according to claim 1, wherein
the active lens comprises a double refraction lens provided in front of the display panel and a polarization switching cell for lens control provided between the double refraction lens and the display panel, and
the defocus processing is conducted by applying voltages of different combinations to the polarization switching cell for lens control.

6. The stereoscopic video display apparatus according to claim 1, further comprising a position detection unit to detect a position of a viewer,
wherein the defocus processing is conducted by using the position of the viewer detected by the position detection unit.

7. A stereoscopic video display method for displaying a video on a stereoscopic video display apparatus including a display panel having a display face on which pixels are arranged in a matrix form, and an active lens disposed in front of the display panel to control light rays from the pixels, the active lens being capable of conducting partial changeover on a focus state of the display face, the stereoscopic video display method comprising:
detecting a region to be subject to focus processing from an image which is input; and
driving the active lens to conduct defocus processing on the detected region to be defocused.
